(19) United States
(12) Patent Application Publication
(10) Pub. No.: US 2024/0427618 A1
(43) Pub. Date: Dec. 26, 2024

(54) UPGRADING VIRTUAL MACHINE MANAGEMENT SOFTWARE THAT EXECUTES WITH REDUNDANCY

(71) Applicant: VMWARE, INC, Palo Alto, CA (US)

(72) Inventors: KRISHNENDU GORAI, Bangalore (IN); Akash Kodenkiri, Bangalore (IN); Ivaylo Radoslavov Radev, Sofia (BG); Vladimir Ivanov, Sofia (BG); Leonid Livshin, Malden, MA (US)

(21) Appl. No.: 18/232,381

(22) Filed: Aug. 10, 2023

(30) Foreign Application Priority Data
Jun. 23, 2023 (IN) 202341042171

(51) Int. Cl. G06F 9/455; G06F 8/71

(52) U.S. Cl. CPC G06F 9/45558; G06F 8/71; G06F 2009/4557; G06F 2009/45595

(57) ABSTRACT

A method of upgrading virtual machine (VM) management software from a first version to a second version, wherein the first version of the VM management software executes in a plurality of workloads of a plurality of host computers, the plurality of workloads including a first active workload executing on a first host computer, a first passive workload executing on a second host computer, and a first witness workload executing on a third host computer, and the method comprising: creating and powering on a second active workload that is configured to execute the second version of the VM management software; copying state information from the first active workload to the second active workload and continuing execution of the VM management software in the second active workload; and creating and powering on a second passive workload and creating and powering on a second witness workload.

### RELATED APPLICATIONS

Benefit is claimed under 35 U.S.C. 119(a)-(d) to Foreign application Ser. No. 20/234,1042171 filed in India entitled “UPGADING VIRTUAL MACHINE MANAGEMENT SOFTWARE THAT EXECUTES WITH REDUNDANCY”, on Jun. 23, 2023, by VMware, Inc., which is herein incorporated in its entirety by reference for all purposes.

### BACKGROUND

In a software-defined data center (SDDC), virtual infrastructure (VI), which includes virtual machines (VMs) and virtualized storage and networking resources, is provisioned from hardware infrastructure. The hardware infrastructure includes a plurality of host computers, referred to herein simply as hosts, and includes storage devices and networking devices. The provisioning of the VI is carried out by SDDC management software that is deployed on management appliances. For example, each management appliance may be a virtual appliance. which is a pre-configured VM. The SDDC management software manages the VI by communicating with virtualization software (e.g., hypervisors) installed in the hosts.

The SDDC management software includes VM management software such as VMware vCenter Server,® available from VMware, Inc. The VM management software provides functions for a cluster, which is a group of hosts that are managed together. For example, the functions include load balancing across the cluster through VM migration between the hosts. The functions further include distributed power management, dynamic VM placement according to affinity and anti-affinity rules, and high availability of VMs.

A typical implementation of the VM management software is a single virtual appliance executing on a single host. However, such an implementation has vulnerabilities. For example, if the host fails, the VM management software becomes unavailable. To account for such vulnerabilities, redundancy may be introduced by applying high availability to the VM management software itself. According to such an approach, the VM management software executes in a plurality of virtual appliances.

A first appliance, referred to herein as an “active” VM management appliance, executes services to provide the functions discussed above. A second appliance, referred to herein as a “passive” VM management appliance, is a clone of the active VM management appliance that is in a standby mode. The active VM management appliance periodically replicates state information to the passive VM management appliance. The passive VM management appliance is configured to execute services in the event of (in response to) the active VM management appliance failing.

A third appliance, referred to herein as a “witness” VM management appliance communicates with the active and passive VM management appliances to resolve which is active and which is passive. If the active VM management appliance fails (and loses connection with the witness VM management appliance), the witness VM management appliance instructs the passive VM management appliance to become active and execute the services therein. The formerly passive VM management appliance then executes services based on the state information replicated from the formerly active VM management appliance. Accordingly, the VM management software continues execution with no outage or loss of state.

Although applying high availability to the VM management software offers the above disaster-recovery mechanisms, applying high availability also creates issues. For example, upgrading the VM management software can be complicated and error prone, resulting in upgrades being time-consuming and even failing entirely. Each of the VM management appliances (active, passive, and witness) must be upgraded to provide an upgraded version of the VM management software along with disaster-recovery mechanisms therefor. A method of safely upgrading VM management software is needed that accounts for complexities introduced by high availability.

### SUMMARY

One or more embodiments provide a method of upgrading VM management software from a first version to a second version. The first version of the VM management software executes in a plurality of workloads of a plurality of host computers, the plurality of workloads including a first active workload executing on a first host computer, a first passive workload executing on a second host computer, and a first witness workload executing on a third host computer. The method includes the steps of: creating and powering on a second active workload that is configured to execute the second version of the VM management software; copying state information from the first active workload to the second active workload and continuing execution of the VM management software in the second active workload; and creating and powering on a second passive workload and creating and powering on a second witness workload, the second passive workload being a clone of the second active workload.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computer system in which embodiments may be implemented for upgrading “self-managed” VM management software.

FIG. 2 is a block diagram of the virtualized computer system in which embodiments may be implemented for upgrading “non-self-managed” VM management software.

FIG. 3 is a flow diagram of a method performed by an active VM management appliance to perform prechecks for an upgrade of VM management software, according to an embodiment.

FIG. 4 is a flow diagram of a method performed by hosts to stop execution of high availability of the VM management software and to create a new active VM management appliance configured to execute an upgraded version of the VM management software, according to an embodiment.

FIG. 5 is a flow diagram of a method performed by a hypervisor of a host to create new passive and witness VM management appliances to complete upgrading of the VM management software, according to an embodiment.

### DETAILED DESCRIPTION

Techniques for upgrading VM management software that executes with redundancy, are described. According to techniques, the VM management software executes in active, passive, and witness VM management appliances. The VM management appliances execute on separate hosts of a virtualized computer system. It should be understood that although the techniques are described with respect to VM management appliances, the VM management software may alternatively execute in different types of workloads. For example, the techniques also apply to an active group of containers instead of an active VM management appliance, a passive group of containers instead of a passive VM management appliance, and a witness group of containers instead of a witness VM management appliance. Such groups of containers may be, e.g., groups of Docker® containers, each container being a standalone unit of software that includes one or more processes executing therein.

To upgrade the VM management software, the computer system first deletes the passive and witness VM management appliances, which reduces storage consumption during the upgrade process and stops replication of state information from the active VM management appliance. Next, a new active VM management appliance is created that is configured to execute an upgraded version of the VM management software. Then, a temporary IP address is assigned to the new active VM management appliance, and state information is copied from the original active VM management appliance to the new one. Finally, new passive and witness VM management appliances are created, the new VM management appliances continuing execution of the VM management software while providing redundancy therefor. The techniques automatically and safely upgrade the VM management software, the original active VM management appliance not being deleted until the upgrade is successfully completed.

The techniques also account for different layouts of the VM management software. For example, administrators may manage multiple clusters of hosts for an organization, each cluster being managed by its own VM management software. In some cases, the VM management software being upgraded executes in the cluster that the VM management software also manages. Such VM management software is referred to herein as being “self-managed.” In other cases, the VM management software being upgraded executes in another cluster that is managed by another VM management appliance. In such cases, the VM management software being upgraded is referred to herein as being “non-self-managed,” and the other VM management software is referred to herein as being “managing.” In the case of upgrading non-self-managed VM management software, the non-self-managed VM management software requests the managing VM management software for hardware resources for performing the upgrade process. These and further aspects of the invention are discussed below with respect to the drawings.

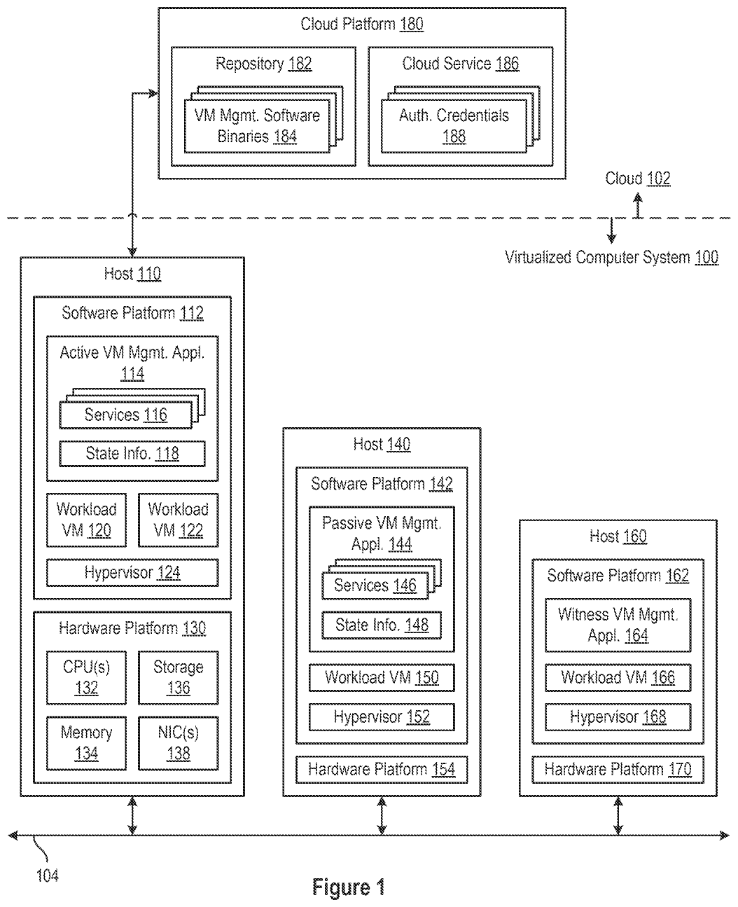

FIG. 1 is a block diagram of a virtualized computer system 100 in which embodiments may be implemented for upgrading self-managed VM management software. Virtualized computer system 100 is managed through a multi-tenant cloud platform 180 implemented in a public cloud 102. Virtualized computer system 100 is implemented in an on-premise data center managed by an organization, a private cloud managed by the organization, a public cloud managed for the organization by another organization, or any combination of these. Virtualized computer system 100 includes a cluster of hosts, the cluster including hosts 110, 140, and 160. VM management software executes in VM management appliances executing across hosts 110, 140, 160. That VM management software manages hosts 110, 140, and 160, including a software and hardware inventory thereof, i.e., the VM management software is self-managed.

Host 110 is constructed on a hardware platform 130 such as an x86 architecture platform. Hardware platform 130 includes conventional components of a computing device, such as one or more central processing units (CPUs) 132, memory 134 such as random-access memory (RAM), local storage 136 such as one or more magnetic drives or solid-state drives (SSDs), and one or more network interface cards (NICs) 138. CPU(s) 132 are configured to execute instructions such as executable instructions that perform one or more operations described herein, which may be stored in memory 134. NIC(s) 138 enable host 110 to communicate with other devices over a network 104 such as a local area network (LAN).

Hardware platform 130 supports a software platform 112. Software platform 112 includes a hypervisor 124, which is a virtualization software layer. Hypervisor 124 supports a VM execution space within which VMs are concurrently instantiated and executed. One example of hypervisor 124 is a VMware ESX® hypervisor, available from VMware, Inc. The VMs include an active VM management appliance 114 and workload VMs 120 and 122. Workload VMs 120 and 122 execute one or more applications of the organization.

Active VM management appliance 114 executes services 116, which are processes performing cluster-level functions such as load balancing across hosts 110, 140, and 160, distributed power management, dynamic VM placement, and high availability of VMs. Active VM management appliance 114 includes state information 118 for executing services 116. For example, state information 118 includes a database of inventory information about hosts 110, 140, and 160 identifying hosts 110, 140, and 160 and VMs executing therein. State information 118 further includes configurations of services 116. For example, for a secure shell (SSH) service of services 116, the configurations may include settings for timeout, session idle timeout, maximum concurrent sessions, and maximum session active time. Active VM management appliance 114 communicates with other devices via a management network (not shown) provisioned from network 104.

Hosts 140 and 160 are constructed on hardware platforms 154 and 170, respectively, such as x86 architecture platforms. Hardware platforms 154 and 170 each include the conventional components of a computing device (not shown) discussed above with respect to hardware platform 130. Hardware platforms 154 and 170 support software platforms 142 and 162, respectively. Software platforms 142 and 162 include hypervisors 152 and 168, respectively, which are virtualization software layers supporting VM execution spaces within which VMs are concurrently instantiated and executed. The VMs of software platform 142 include a passive VM management appliance 144 and a workload VM 150. The VMs of software platform 162 include a witness VM management appliance 164 and a workload VM 166. Workload VMs 150 and 166 execute one or more applications of the organization.

Passive VM management appliance 144 is configured to execute services 146. Services 146 are processes performing the cluster-level functions discussed above with respect to services 116. However, services 146 are in a standby mode, passive VM management appliance 144 executing services 146 in response to active VM management appliance 114 failing. Passive VM management appliance 144 includes state information 148 for executing services 146, state information 148 being a copy of state information 118. Active VM management appliance 114 periodically replicates state information 118 to passive VM management appliance 144 across the management network provisioned from network 104.

Witness VM management appliance 164 communicates with active and passive VM management appliances 114 and 144 to resolve which is active and which is passive. If active VM management appliance 114 fails and loses connection with witness VM management appliance 164, witness VM management appliance 164 instructs passive VM management appliance 144 to become active and begin executing services 146 based on state information 148. Because state information 148 is a copy of state information 118, the VM management software continues execution with no outage or loss of state.

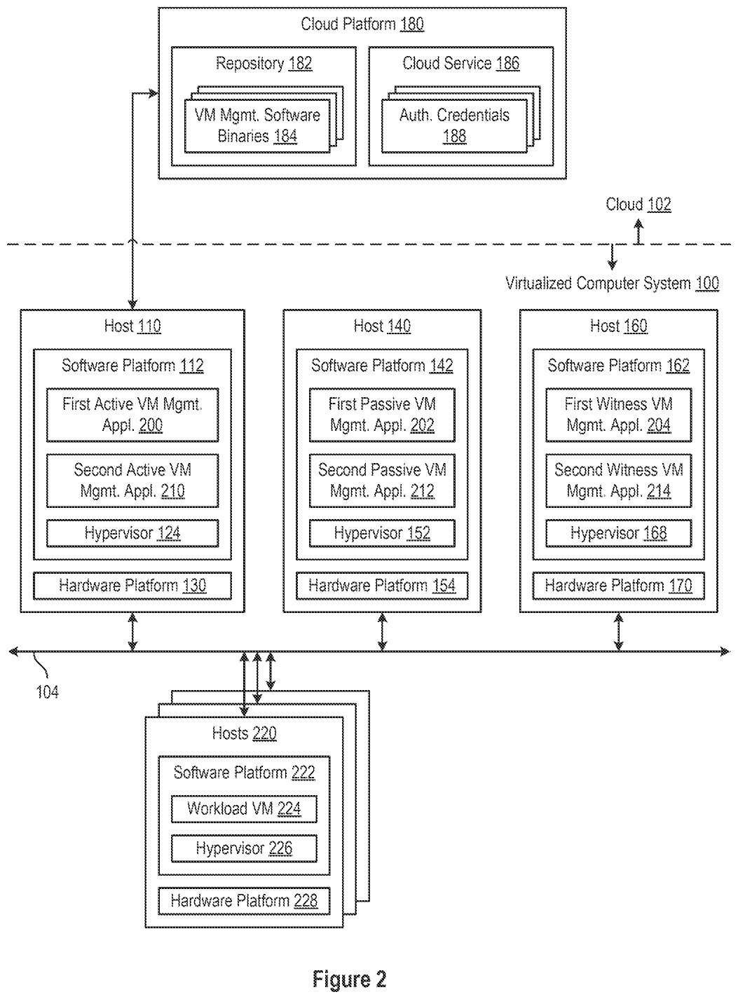

Hosts of virtualized computer system 100 communicate with cloud platform 180, e.g., over the Internet. Cloud platform 180 includes a repository 182 and a cloud service 186 among other cloud services (not shown) for managing hosts 110, 140, and 160. Repository 182 is a database that centrally stores software binaries. Such software binaries include VM management software binaries 184, which are binaries of various versions of the VM management software. A group of such binaries is downloaded to virtualized computer system 100 to upgrade the virtualization management software. Cloud service 186 is a microservice that stores authentication credentials 188. For example, cloud service 186 may execute as a container such as a Docker® container. Authentication credentials 188 include one or more of a password, cryptographic token, and fingerprint for authenticating with the VM management software. Authentication credentials 188 will be discussed further below in conjunction with FIG. 2.

FIG. 2 is a block diagram of virtualized computer system 100 in which embodiments may be implemented for upgrading non-self-managed VM management software. Items of FIG. 2 that are common with items of FIG. 1 have the same functionality and numbering and will not be reexplained. In FIG. 2, two instances of VM management software execute across hosts 110, 140, 160. A first instance of VM management software manages the cluster that includes hosts 110, 140, and 160, including a software and hardware inventory thereof. A second instance of VM management software manages a separate cluster that includes hosts 220, including a software and hardware inventory thereof. However, the second instance executes in hosts 110, 140, and 160. The second instance is thus non-self-managed, and if the second instance is to be upgraded, the first instance is the managing VM management software.

The first instance of the VM management software, which is the managing VM management software, executes in a first active VM management appliance 200, a first passive VM management appliance 202, and a first witness VM management appliance 204. First active VM management appliance 200 executes services (not shown), which perform cluster-level functions such as load balancing across hosts 110, 140, and 160, distributed power management, dynamic VM placement, and high availability of VMs. First passive VM management appliance 202 is configured to execute the same services, but which are in a standby mode. First witness VM management appliance 204 communicates with first active and passive VM management appliances 200 and 202 to resolve which is active and which is passive.

The second instance of the VM management software, which is non-self-managed, executes in a second active VM management appliance 210, a second passive VM management appliance 212, and a second witness VM management appliance 214. Second active VM management appliance 210 executes services (not shown), which perform cluster-level functions such as load balancing across hosts 220, distributed power management, dynamic VM placement, and high availability of VMs. Second passive VM management appliance 212 is configured to execute the same services, but which are in a standby mode. Second witness VM management appliance 214 communicates with second active and passive VM management appliances 210 and 212 to resolve which is active and which is passive.

If the second instance of the VM management software is to be upgraded, the second instance of the VM management software authenticates with the first instance of the VM management software. To authenticate, the second instance of the VM management software first obtains authentication credentials 188 of the first instance of the VM management software from cloud service 186. Second active VM management appliance 210 then transmits the authentication credentials to first active VM management appliance 200. Second active VM management appliance 210 also transmits a request for hardware resources of hosts 110, 140, and 160 for creating and executing new active, passive, and witness VM management appliances across hosts 110, 140, and 160. The new active, passive, and witness VM management appliances are to execute an upgraded version of VM management software.

Each of hosts 220 is constructed on a hardware platform 228 such as an x86 architecture platform. Hardware platform 228 includes the conventional components of a computing device (not shown) discussed above with respect to hardware platform 130. Hardware platform 228 supports a software platform 222. Software platform 222 includes a hypervisor 226, which is a virtualization software layer supporting a VM execution space within which VMs are concurrently instantiated and executed. The VMs of software platform 222 include a workload VM 234, which executes one or more applications of the organization.

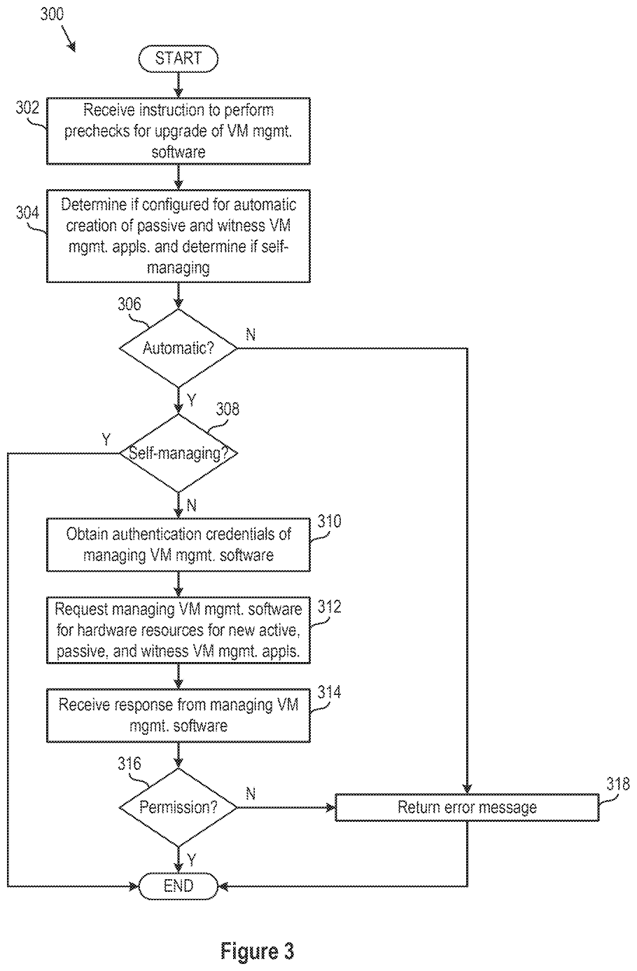

FIG. 3 is a flow diagram of a method 300 performed by an active VM management appliance to perform prechecks for an upgrade of VM management software therein, according to an embodiment. Method 300 is triggered by an administrator downloading an upgraded version of the VM management software from repository 182 and electing to upgrade the VM management software executing in the active VM management appliance. At step 302, the active VM management appliance receives an instruction to perform prechecks for an upgrade of the VM management software.

At step 304, as a first precheck, the active VM management appliance determines if the VM management software is configured for automatic creation and placement of passive and witness VM management appliances. Specifically, the active VM management appliance determines if the VM management software automatically creates passive and witness VM management appliances and automatically places them on hosts, e.g., in a manner that balances hardware resource consumption among hosts within a cluster. Otherwise, the administrator manually determines where to place passive and witness VM management appliances. Furthermore, as a second precheck, the active VM management appliance determines if its VM management software is self-managing. The active VM management appliance determines the information of the prechecks by checking its state information.

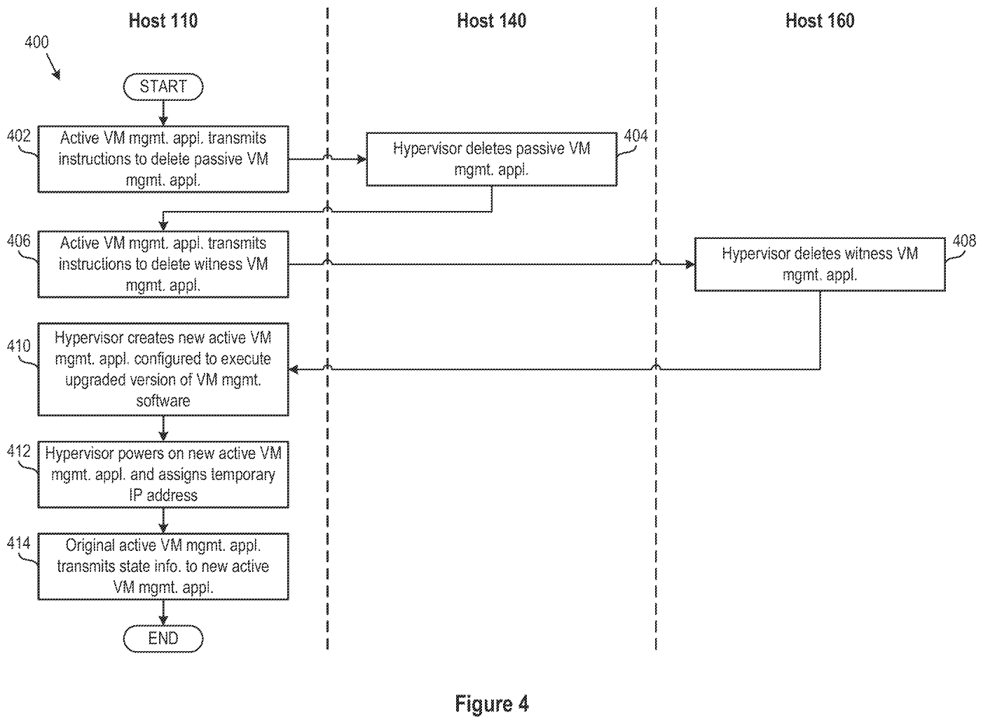

At step 306, if the VM management software is not configured for automatic creation and placement of passive and witness VMs, method 300 moves to step 318. The active VM management appliance returns an error message, instructing the administrator to allow for automatic creation and placement of passive and witness VMs to enable automatic upgrading of the VM management software, and method 300 ends. Returning to step 306, if the VM management software is configured for automatic creation and placement of passive and witness VMs, method 300 moves to step 308. At step 308, if the VM management software is self-managing, method 300 ends, and the upgrade process continues to the steps of FIG. 4. Otherwise, if the VM management software is non-self-managing, method 300 moves to step 310.

At step 310, the active VM management appliance obtains authentication credentials 188 from cloud service 186 such as a password, cryptographic token, and/or fingerprint of the managing VM management software. At step 312, the active VM management appliance requests the managing VM management software for hardware resources for new active, passive, and witness VM management appliances. The request includes the authentication credentials obtained at step 310 to be verified by the managing VM management software. At step 314, the active VM management appliance receives a response from the managing VM management software. The response may indicate that hardware resources have been allocated for creating new VM management appliances and indicate which hosts to deploy the new VM management appliances on. Alternatively, the response may indicate that the active VM management appliance does not have permission, e.g., because the authentication credentials are incorrect or because there is insufficient storage for creating new VM management appliances.

At step 316, if the response indicates that the active VM management appliance does not have permission to create new VM management appliances in the managing VM management software's cluster, method 300 moves to step 318. At step 318, the active VM management appliance returns an error message indicating the lack of permission to perform the upgrade, and method 300 ends. Returning to step 316, if the response indicates that hardware resources have been allocated (and that the active VM management appliance does have permission), method 300 ends, and the upgrade process continues to the steps of FIG. 4.

FIG. 4 is a flow diagram of a method 400 performed by hosts 110, 140, and 160 to stop execution of high availability of the VM management software and to create a new active VM management appliance configured to execute an upgraded version of the VM management software, according to an embodiment. At step 402, the active VM management appliance transmits instructions to host 140 to delete the corresponding passive VM management appliance. At step 404, in response to the instructions, hypervisor 152 deletes the passive VM management appliance. At step 406, the active VM management appliance transmits instructions to host 160 to delete the corresponding witness VM management appliance. At step 408, in response to the instructions, hypervisor 168 deletes the witness VM management appliance.

At step 410, hypervisor 124 creates a new active VM management appliance from a group of binaries of an upgraded version of the VM management software, the binaries having been downloaded from repository 182. The new active VM management appliance is configured to execute the upgraded version. If the VM management software being upgraded is self-managed, the VM management software determines which host to place the new active VM management appliance on. Otherwise, if non-self-managed, the VM management software to be upgraded is provided a target host by the managing VM management software for placing the new active VM management appliance.

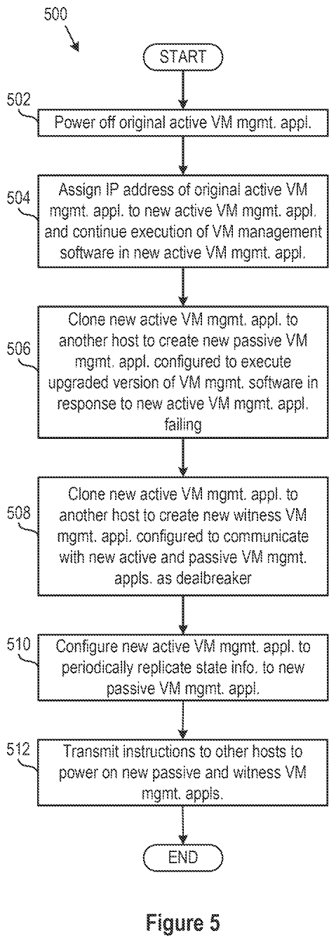

At step 412, hypervisor 124 powers on the new active VM management appliance and assigns a temporary internet protocol (IP) address thereto. The temporary IP address is used for replicating state information from the original active VM management appliance before continuing execution of the VM management software in the new active VM management appliance. At step 414, the original active VM management appliance transmits state information to the new active VM management appliance. The state information includes a software and hardware inventory of a cluster managed by the original active VM management appliance. The state information also includes configurations of services of the original active VM management appliance. After step 414, method 400 ends, and the upgrade process continues to the steps of FIG. 5.

FIG. 5 is a flow diagram of a method 500 performed by hypervisor 124 to create new passive and witness VM management appliances to complete upgrading of the VM management software, according to an embodiment. At step 502, hypervisor 124 powers off the original active VM management appliance. At step 504, hypervisor 124 selects the IP address assigned to the original active VM management appliance. Hypervisor 124 reassigns the IP address to the new active VM management appliance and continues execution of the VM management software as an upgraded version thereof in the new active VM management appliance.

At step 506, hypervisor 124 clones the new active VM management appliance to another host (e.g., host 140) to create a new passive VM management appliance thereon. At step 508, hypervisor 124 clones the new active VM management appliance to another host (e.g., host 160) to create a new witness VM management appliance thereon. If the VM management software being upgraded is self-managed, the VM management software determines which hosts to place the new passive and witness VM management appliances on. Otherwise, if non-self-managed, the VM management software to be upgraded is provided target hosts by the managing VM management software for placing the new passive and witness VM management appliances.

The new passive VM management appliance is configured to execute the upgraded version of the VM management software in response to being informed of the new active VM management appliance failing. The new witness VM management appliance is configured to communicate with the new active and passive VM management appliances as a dealbreaker (to resolve which is active and which is passive). Such configuration includes providing IP addresses of the new active and passive VM management appliances to the new witness VM management appliance. In particular, if the new witness VM management appliance loses connection with the new active VM management appliance, the new witness VM management appliance instructs the new passive VM management appliance to become active and execute services of the upgraded VM management software. The new witness VM management appliance includes the same binaries as the new active and passive VM management appliances and is thus compatible and can communicate therewith.

At step 510, hypervisor 124 configures the new active VM management appliance to periodically replicate state information to the new passive VM management appliance. Such configuration includes providing an internet protocol (IP) address of the new passive VM management appliance to the new active VM management appliance. It should be noted that the new active VM management appliance does not replicate state information to the new witness VM management appliance. Unlike the new passive VM management appliance, the new witness VM management appliance does not remain a mirrored copy of the new active VM management appliance. At 512, hypervisor 124 transmits instructions to the other hosts (e.g., hosts 140 and 160) to power on the new passive and witness VM management appliances.

After step 512, method 500 ends, and the other hosts power on and execute the new passive and witness VM management appliances. The new active, passive, and witness VM management appliances then provide the upgraded VM management software with redundancy. The new active VM management appliance executes services of the upgraded VM management software with the configurations from the original active VM management appliance. The new active VM management appliance also periodically replicates state information to the new passive VM management appliance, and the new witness VM management appliance acts as a dealbreaker. If the upgrade is successful (and the upgraded VM management software executes properly), hypervisor 124 deletes the original active VM management appliance.

It should be noted that an error may be encountered at some point during the upgrade process, e.g., while executing the new active, passive, and witness VM management appliances. In such a case, all data related to new VM management appliances is deleted. Hypervisors 124, 152, and 168 delete the new active, passive, and witness VM management appliances. The original passive and witness VM management appliances are recreated, and the original active, passive, and witness VM management appliances are powered on to provide the original VM management software with redundancy. The upgrade process is thus safe because failed upgrades do not result in outage of the VM management software.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of upgrading first virtual machine (VM) management software from a first version to a second version, wherein the first version of the first VM management software executes in a plurality of workloads of a plurality of host computers, the plurality of workloads including a first active workload executing on a first host computer, a first passive workload executing on a second host computer, and a first witness workload executing on a third host computer, and the method comprising:
creating and powering on a second active workload that is configured to execute the second version of the first VM management software;
copying state information from the first active workload to the second active workload and continuing execution of the first VM management software in the second active workload; and
creating and powering on a second passive workload and creating and powering on a second witness workload, the second passive workload being a clone of the second active workload.

2. The method of claim 1, further comprising:
before creating the second active workload, transmitting instructions to the second host computer to delete the first passive workload; and
before creating the second active workload, transmitting instructions to the third host computer to delete the first witness workload.

3. The method of claim 1, wherein the second passive workload is configured to execute the second version of the first VM management software in response to the second active workload failing, and the second witness workload is configured to instruct the second passive workload to execute services of the second version of the first VM management software in response to the second active workload failing.

4. The method of claim 1, further comprising:
before copying the state information, assigning a first internet protocol (IP) address to the second active workload; and
after copying the state information, assigning a second IP address to the second active workload based on the second IP address having been previously assigned to the first active workload.

5. The method of claim 1,
wherein the second passive workload is created on the second host computer, the second passive workload executing on the second host computer upon being powered on, and
wherein the second witness workload is created on the third host computer, the second witness workload executing on the third host computer upon being powered on.

6. The method of claim 1, wherein the state information includes configurations of services of the first version of the first VM management software, and upon continuing the first VM management software, services of the second version of the first VM management software execute with the configurations.

7. The method of claim 1, wherein the state information includes inventory information identifying workload VMs executing on host computers managed by the first VM management software, the host computers managed by the first VM management software including the first, second, and third host computers.

8. The method of claim 1, wherein the state information includes inventory information identifying workload VMs executing on host computers managed by the first VM management software, the host computers managed by the first VM management software not including the first, second, and third host computers.

9. The method of claim 8, further comprising:
requesting second VM management software for hardware resources for creating the second active, second passive, and second witness workloads.

10. The method of claim 9, wherein requesting the second VM management software for the hardware resources involves transmitting authentication credentials to the second VM management software for the second VM management software to verify.

11. A non-transitory computer-readable medium comprising instructions that are executable in a computer system, wherein the instructions when executed cause the computer system to carry out a method of upgrading first virtual machine (VM) management software from a first version to a second version, and wherein the first version of the first VM management software executes in a plurality of workloads of a plurality of host computers, the plurality of workloads including a first active workload executing on a first host computer, a first passive workload executing on a second host computer, and a first witness workload executing on a third host computer, and the method comprising:
creating and powering on a second active workload that is configured to execute the second version of the first VM management software;
copying state information from the first active workload to the second active workload and continuing execution of the first VM management software in the second active workload; and
creating and powering on a second passive workload and creating and powering on a second witness workload, the second passive workload being a clone of the second active workload.

12. The non-transitory computer-readable medium of claim 11, wherein the method further comprises:
before creating the second active workload, transmitting instructions to the second host computer to delete the first passive workload; and
before creating the second active workload, transmitting instructions to the third host computer to delete the first witness workload.

13. The non-transitory computer-readable medium of claim 11, wherein the second passive workload is configured to execute the second version of the first VM management software in response to the second active workload failing, and the second witness workload is configured to instruct the second passive workload to execute services of the second version of the first VM management software in response to the second active workload failing.

14. The non-transitory computer-readable medium of claim 11, wherein the method further comprises:
before copying the state information, assigning a first internet protocol (IP) address to the second active workload; and
after copying the state information, assigning a second IP address to the second active workload based on the second IP address having been previously assigned to the first active workload.

15. A computer system comprising:
a plurality of host computers in a cluster, wherein the plurality of host computers includes a first host computer on which a first active workload executes, a second host computer on which a first passive workload executes, and a third host computer on which a first witness workload executes, and wherein the first host computer is configured to execute on a processor of a hardware platform to upgrade first virtual machine (VM) management software from a first version, which executes in the first active, first passive, and first witness workloads, to a second version, by:
creating and powering on a second active workload that is configured to execute the second version of the first VM management software;
copying state information from the first active workload to the second active workload and continuing execution of the first VM management software in the second active workload; and
creating and powering on a second passive workload and creating and powering on a second witness workload, the second passive workload being a clone of the second active workload.

16. The computer system of claim 15,
wherein the second passive workload is created on the second host computer, the second passive workload executing on the second host computer upon being powered on, and
wherein the second witness workload is created on the third host computer, the second witness workload executing on the third host computer upon being powered on.

17. The computer system of claim 15, wherein the state information includes configurations of services of the first version of the first VM management software, and upon continuing the first VM management software, services of the second version of the first VM management software execute with the configurations.

18. The computer system of claim 15, wherein the state information includes inventory information identifying workload VMs executing on host computers managed by the first VM management software, the host computers managed by the first VM management software including the first, second, and third host computers.

19. The computer system of claim 15, wherein the state information includes inventory information identifying workload VMs executing on host computers managed by the first VM management software, the host computers managed by the first VM management software not including the first, second, and third host computers.

20. The computer system of claim 19, wherein the first host computer is further configured to:
request second VM management software for hardware resources for creating the second active, second passive, and second witness workloads, wherein requesting the second VM management software for the hardware resources involves transmitting authentication credentials to the second VM management software for the second VM management software to verify.
